(19) United States
(12) Patent Application Publication
(10) Pub. No.: US 2021/0184378 A1
(43) Pub. Date: Jun. 17, 2021

(54) ELETRICAL ASSEMBLY FOR USE WITH CARD EDGE CONNECTOR AND CABLE IN SYSTEM

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: TERRANCE F. LITTLE, Fullerton, CA (US)

(21) Appl. No.: 17/117,577

(22) Filed: Dec. 10, 2020

Related U.S. Application Data
(60) Provisional application No. 62/946,945, filed on Dec. 11, 2019.

(51) Int. Cl. H01R 12/72; H01R 12/79; H01R 13/6581; H01R 31/06; H01R 13/424

(52) U.S. Cl. CPC H01R 12/721; H01R 12/724; H01R 13/424; H01R 13/6581; H01R 31/06; H01R 12/79

(57) ABSTRACT

An electrical connector is equipped with one cable secured on a rear side, and an electronic card detachably attached on a front side opposite to the rear side in a front-to-back direction. The connector includes an insulative housing forming in the front side a central receiving slot with two rows of passageways by two sides of the central slot in a transverse direction perpendicular to the front-to-back direction. Each passageway extends through the housing in the front-to-back direction. Two rows of contacts are respectively inserted forwardly into the corresponding passageways from the rear side. A front positioning block is unitarily formed on the rear side and includes a plurality of partitions so as to regulate the connecting sections of the contacts. A rear positioning block is discrete from the housing and located behind the front positioning block to regulate the wires of the cable.

### CROSS REFERENCE TO RELATED APPLICATIONS

This application claims the benefit of, priority to, U.S. Provisional Patent Application No. 62/946945 filed Dec. 11, 2019, the contents of which are incorporated entirely herein by reference

### BACKGROUND OF THE DISCLOSURE

### 1. Field of the Disclosure

The present disclosure relates to an electrical assembly, and more particularly to a card edge connector with the wires permanently secured to one side, and an electronic card detachably attached to the other side.

### 2. Description of Related Arts

To reduce unwanted impedance or energy loss during signal transmission on the conductive traces on the main printed circuit board, a cable composed of plural wires is used to connect two opposite regions on the main board wherein the two opposite ends are respectfully equipped with corresponding connectors for mating with the corresponding board-mount mating connectors which are mounted upon the main board. Notably, other board-mount connectors are proximal to the corresponding board-mount connectors so as to electrically connect other/external components to those corresponding board-mount mating connectors for operation of those other/external components. Anyhow, the arrangement of using too many connectors along the transmission line also affects efficiencies of signal transmission disadvantageously.

An improved arrangement is desired to have the cable directly electrically connect to the other component via a signal connector rather than cooperation of plural connectors.

### SUMMARY OF THE DISCLOSURE

An object of the invention is to provide an electrical connector with one cable secured on a rear side, and an electronic card detachably attached on a front side opposite to the rear side in a front-to-back direction. The connector includes an insulative housing forming in the front side a central receiving slot with two rows of passageways by two sides of the central slot in a transverse direction perpendicular to the front-to-back direction. Each passageway extends through the housing in the front-to-back direction. Two rows of contacts are respectively inserted forwardly into the corresponding passageways from the rear side. Each contact includes a front contacting section extending into the central slot, and a rear connecting section exposed on the rear side.

Another object of the invention is to provide an electrical assembly with mated receptacle connector and plug connector. Both the receptacle connector and the plug connector are equipped with corresponding metallic inner shells for grounding and shielding and corresponding insulative outer shell for coupling and locking wherein the plug connector further includes a resilient latch engageable with a locking step formed on the receptacle connector.

Other objects, advantages and novel features of the disclosure will become more apparent from the following detailed description when taken in conjunction with the accompanying drawings.

### BRIEF DESCRIPTION OF THE DRAWINGS

FIG. 1 is a perspective view of an electrical assembly according to a first embodiment of the invention;

FIG. 2 is another perspective view of the electrical assembly of FIG. 1;

FIG. 3 is a perspective view of an inner side part of the electrical assembly of FIG. 1 without the over-molding cover of the corresponding electrical connector is removed away therefrom;

FIG. 4(A) is a further exploded perspective view of the inner side part of the electrical assembly of FIG. 3;

FIG. 4(B) is another exploded perspective view of the inner side part of the electrical assembly of FIG. 4;

FIG. 5 is a perspective view of the electrical connector of the electrical assembly of FIG. 1 with the associated cable wherein the over-molding cover is removed therefrom;

FIG. 6(A) is an exploded perspective view of the electrical connector of the electrical assembly of FIG. 5;

FIG. 6(B) is another exploded perspective view of the electrical connector of the electrical assembly of FIG. 6(A);

FIG. 7(A) is a perspective view of the electrical connector of the electrical assembly of FIG. 5.

FIG. 7(B) is another perspective view of the electrical connector of the electrical assembly of FIG. 7(A);

FIG. 8(A) is an exploded perspective view of the inner side part of the electrical assembly of FIG. 3;

FIG. 8(B) is another exploded perspective view of the inner side part of the electrical assembly of FIG. 8(A);

FIG. 9 is a side view of the inner side part of the electrical assembly of FIG. 3

FIG. 10 is a cross-sectional view of the inner side part of the electrical assembly of FIG. 3;

FIG. 11 is another cross-sectional view of the inner side part of the electrical assembly of FIG. 3;

FIG. 12(A) is an exploded perspective view of the electrical connector of the electrical assembly with the associated cable wherein the over-molding cover is removed therefrom, according to a second embodiment of the invention;

FIG. 12(B) is another exploded perspective view of the electrical connector of the electrical assembly of FIG. 12(B);

FIG. 13(A) is an exploded perspective view of the inner side part of the electrical assembly of FIG. 12(A);

FIG. 13(B) is another exploded perspective view of the inner side part of the electrical assembly of FIG. 13(A);

FIG. 14 is a cross-sectional view of the inner side part of the electrical assembly of FIG. 12(A); and

FIG. 15 is another cross-sectional view of the inner side part of the electrical assembly of FIG. 12(A).

### DETAILED DESCRIPTION OF THE PREFERRED EMBODIMENT

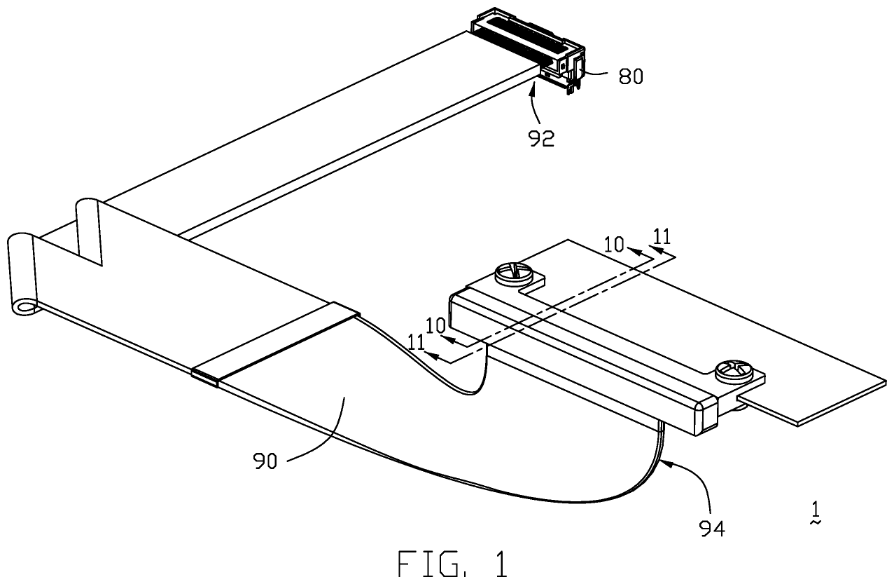

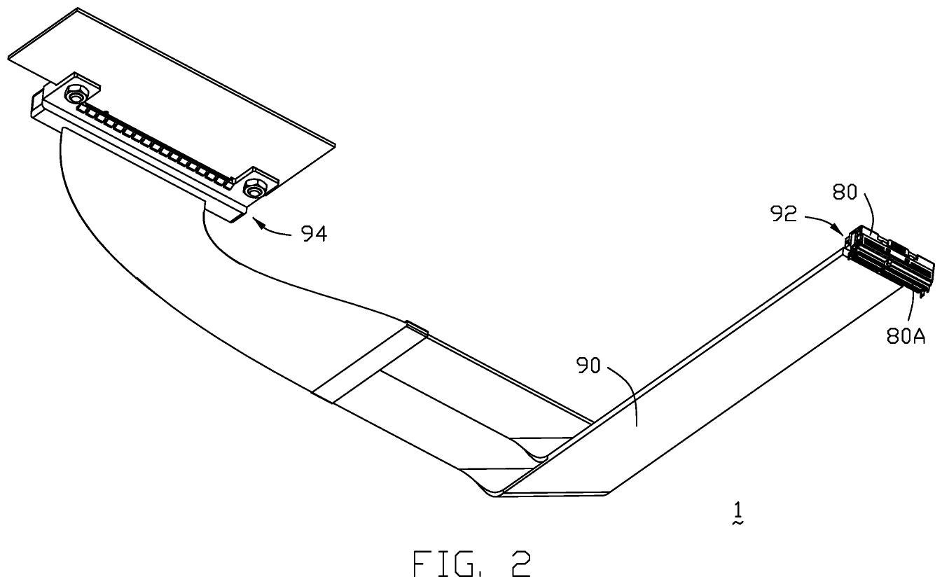

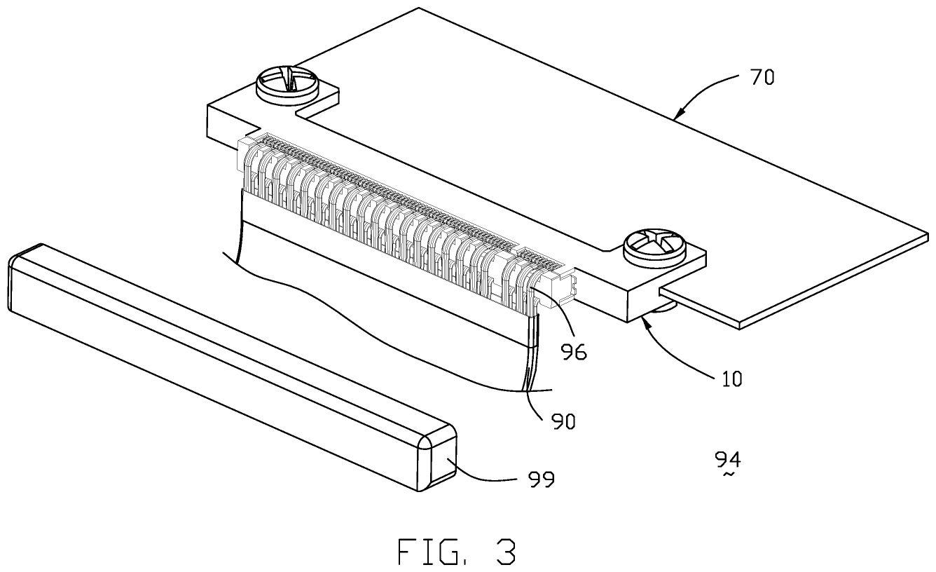

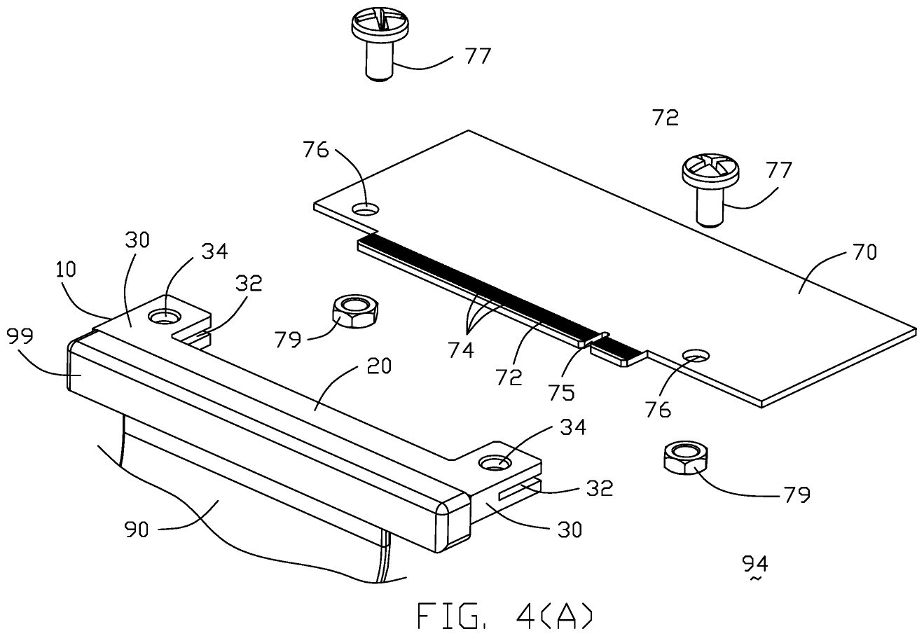

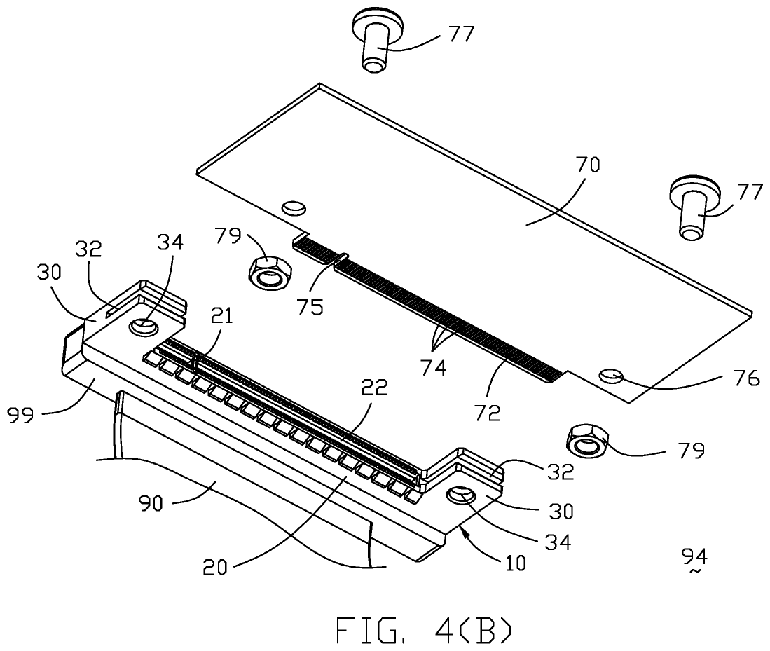

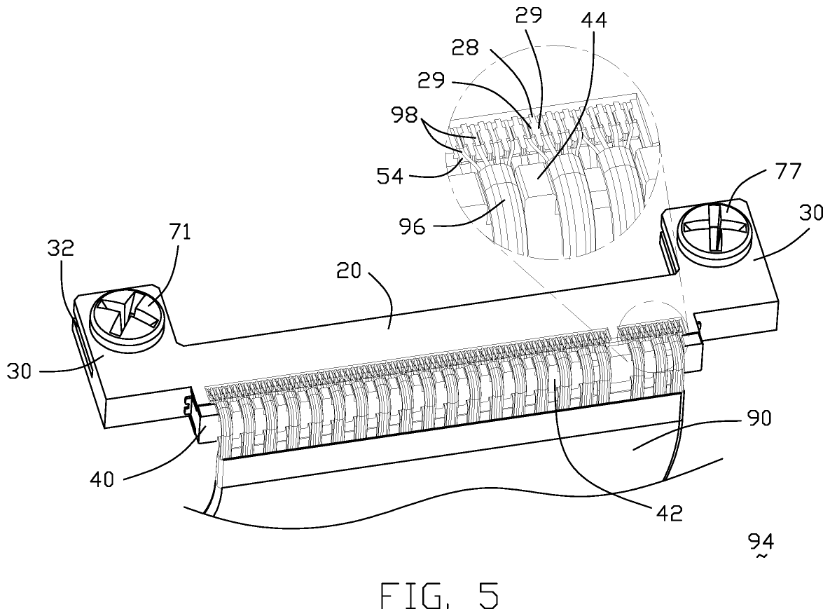

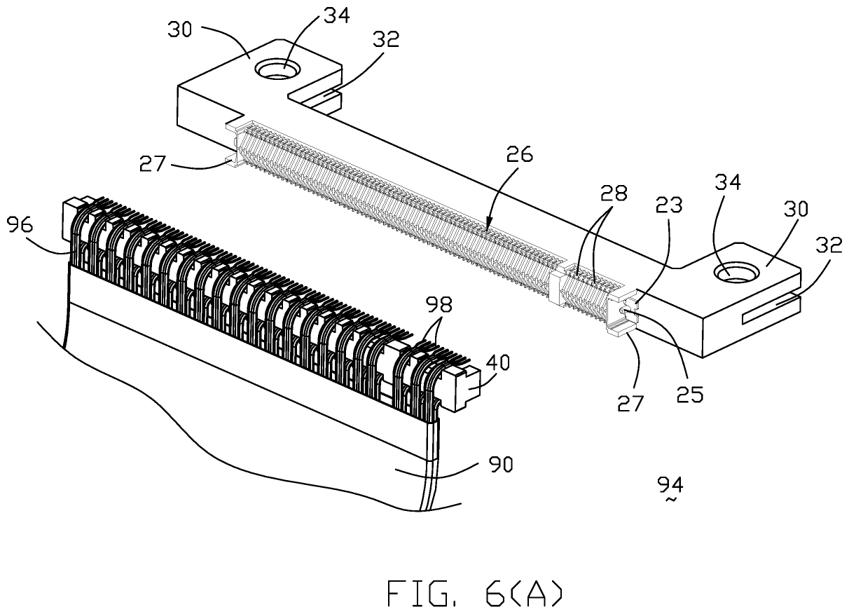

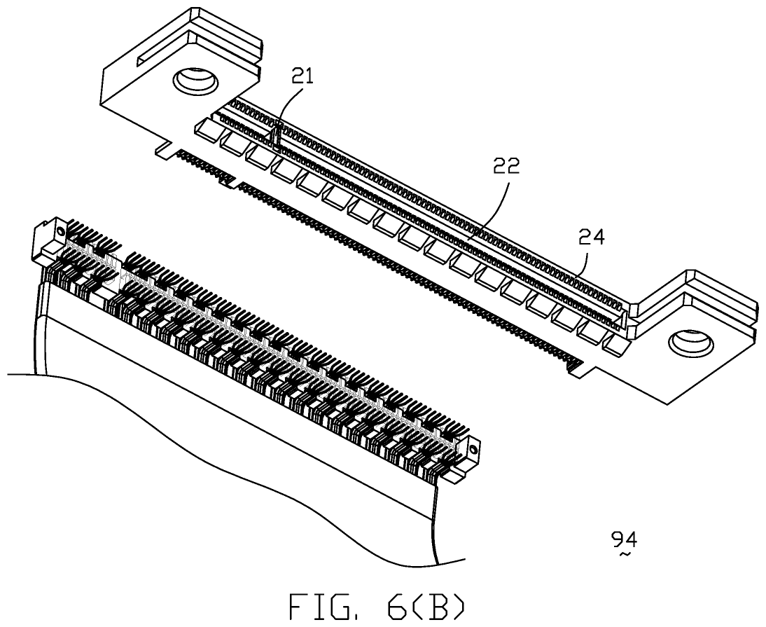

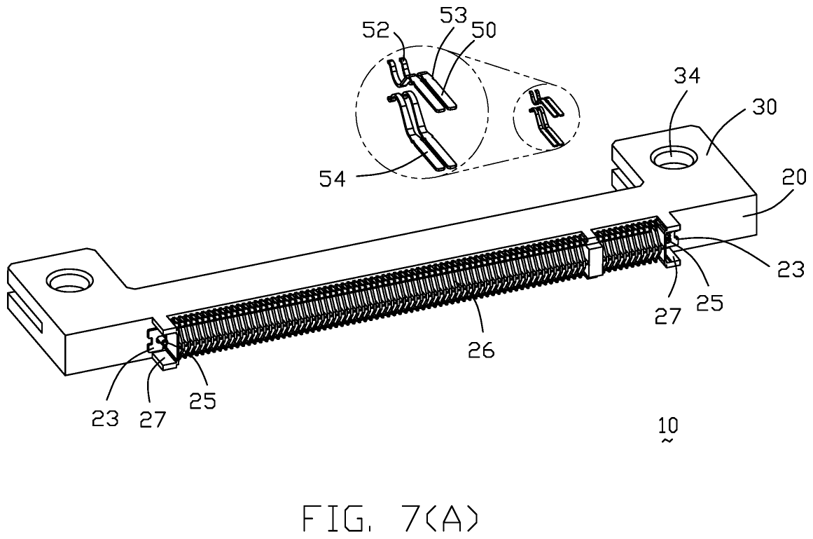

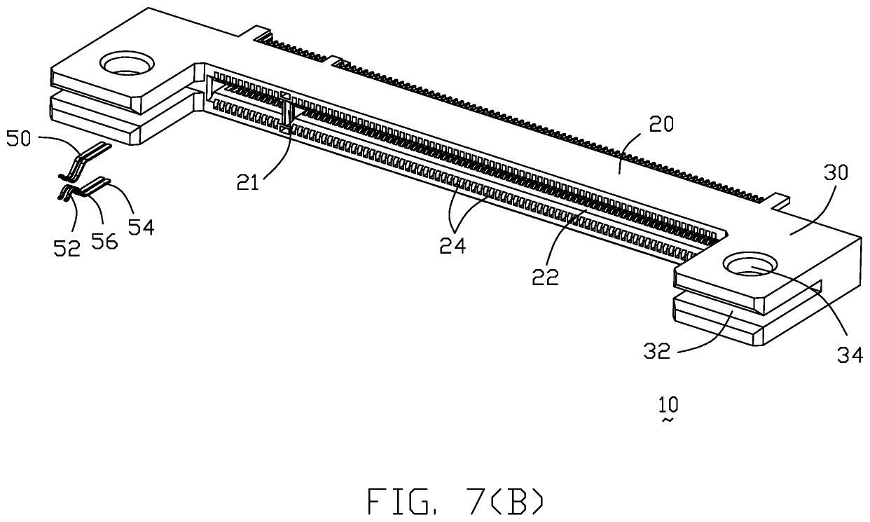

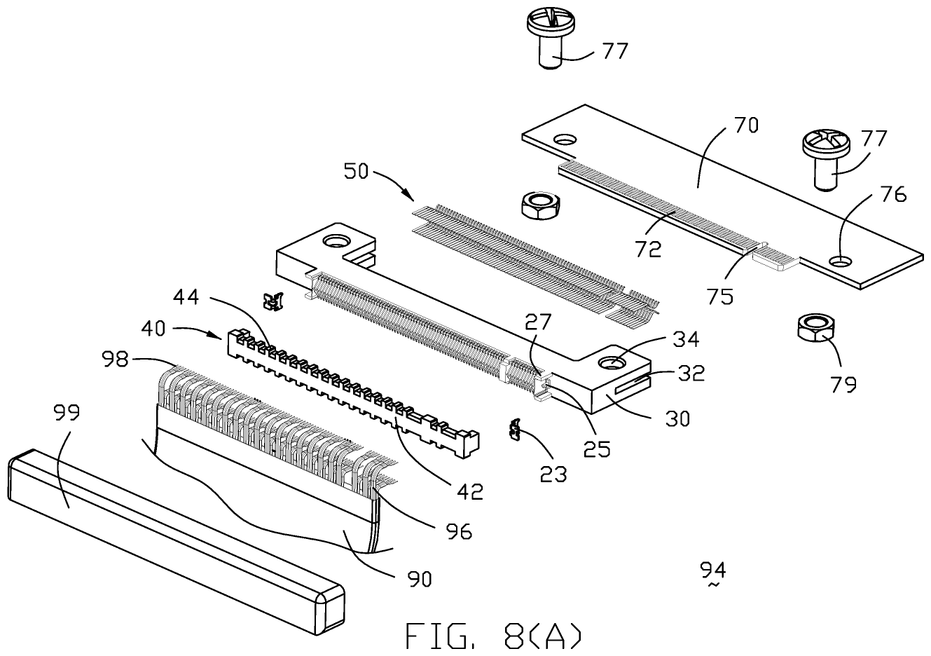

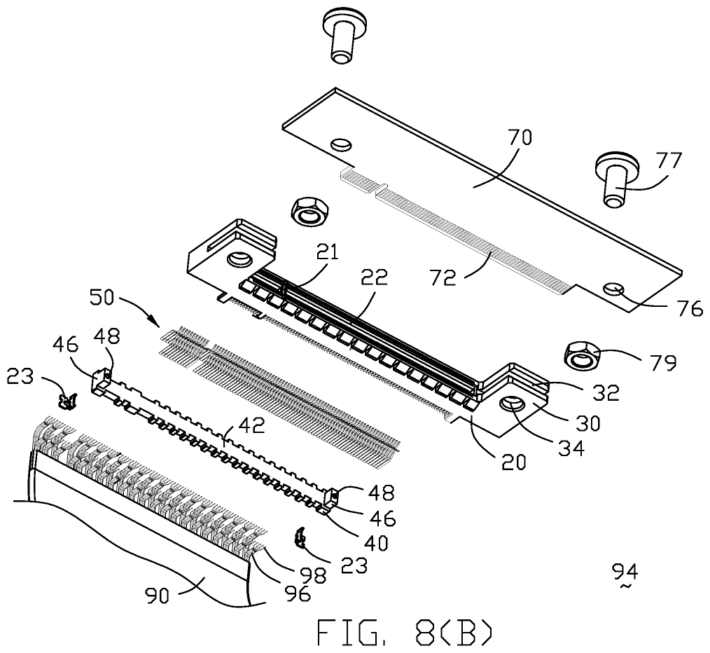

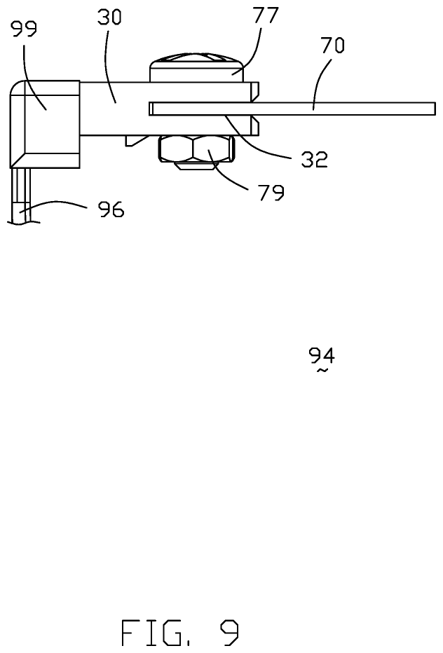

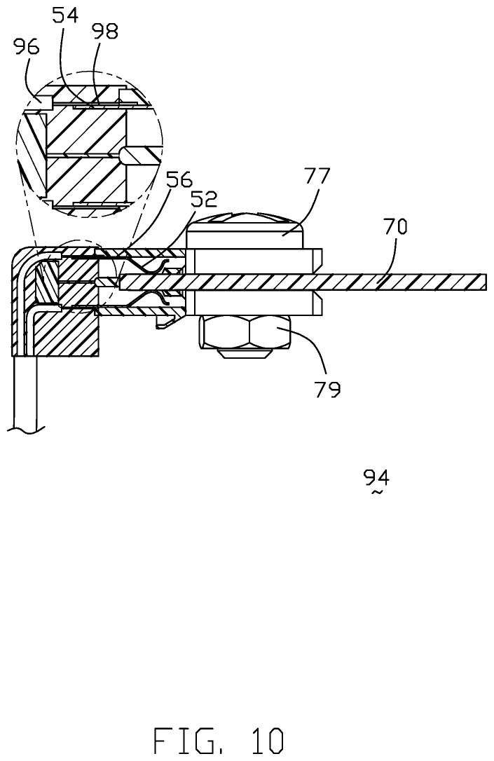

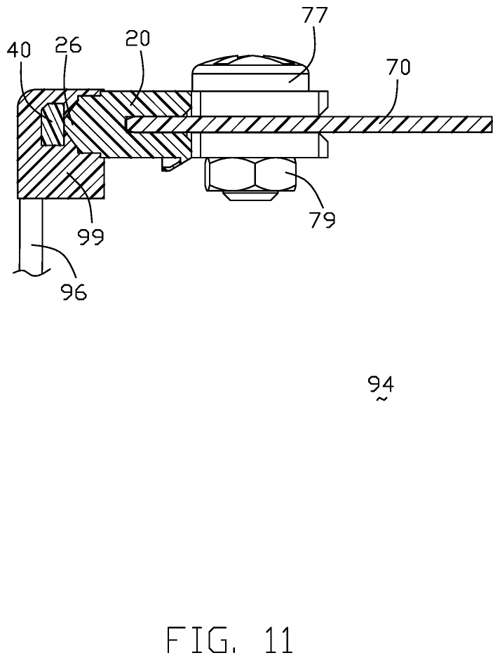

Referring to FIGS. 1-11, an electrical assembly 1 includes a flat cable 90 composed of a plurality of coaxial wires 96 and equipped with an outer side part 92 including an outside connector 80 at the outer end region of the cable 90 wherein the outside connector 80 can be MCIO, GenZ or SlimLine type connector. The outside connector 80 is used to mate with a board connector 80A mounted on a printed circuit board (not shown). The cable 90 further includes an inner side part 94 at the inner end region. The inner side part 94 includes an electrical connector 10 connected to an inner end region of the cable 90. The electrical connector 10 is used to mate with an electric card 70, that means the electrical connector 10 is a kind of card edge connector. The card edge connector 10 includes a longitudinal insulative housing 20 forming a rear side and a front side opposite to each other in the front-to-back direction, the front side is defined to contract with the electrical card 80. The housing 20 forms a central slot 22 extending along a longitudinal direction perpendicular to the front-to-back direction in the front side, and two rows of passageways 24 located by two sides of the central slot 22 in the transverse direction perpendicular to both the front-to-back direction and the longitudinal direction, wherein each row of the passageways extends along the longitudinal direction while each passageway extends through the housing 20 in the front-to-back direction. An alignment key 21 is formed in the central slot 22 for orientation consideration of the mated electronic card 70.

Two rows of contacts 50 are forwardly inserted, from the rear side of the housing 20, into the corresponding passageways 24, respectively. Each contact 50 includes a front deflectable contacting section 52 extending into the central slot 22, a rear connecting section 54 exposed outside the rear side, and a middle retaining section 56 with barbed structures 53 for retaining the contact 50 in position within the corresponding passageway 24. A front positioning block 26 includes a plurality of partitions 28 unitarily formed on a rear side of the housing 20 along so as to separate/isolate the connecting sections 54 of the neighboring contacts 50 from one another along the longitudinal direction. Each partition 28 further forms a pair of sideward protrusions 29 for confining the inner conductors 98 of the tiny wires (not labeled) of the corresponding wire 96 of the cable 90, which will be illustrated later. The pair of sideward protrusions 29 also prevent each connecting section 54 from an upward movement.

A rear positioning block 40 discrete from the housing 20, includes a longitudinal main body 42 extending along the longitudinal direction, and two rows of dividers 44 formed on opposite upper and lower surfaces for separating/isolating the neighboring wires 96. The housing 20 forms a pair of receiving seats 27 at two opposite ends of the front positioning block 26, each receiving seat 27 being equipped with a post 25 and an L-shaped reinforcement pad 23. The rear positioning block 40 forms a pair of protrusions 46 at two opposite ends to be received within the corresponding receiving seats 27, respectively. Each protrusion 46 forms a pocket 48 to receive the corresponding post 25 for alignment consideration. Notably, the wire 96 is received within the corresponding groove formed between two adjacent dividers 44, and the corresponding inner conductor 98 is received within the space between the two corresponding sideward protrusions 29 of the two partitions 28 to be secured/soldered to the connecting section 54 of the corresponding contact 50. An over-molding cover 99 encloses the front portions of the wires 96, including the rear positioning block 40 and the front positioning block 26. In this embodiment, the over-molding cover 99 may enter a rear part of the corresponding passageways 24.

The housing 20 further includes a pair of side arms 30 forwardly extending from two opposite longitudinal ends and at opposite ends of the central slot 22. Each side arm 30 forms a groove 32 in alignment with the central slot 22. Each side arm 30 includes a securing hole 34 therein along the transverse direction. The electronic card 70, i.e., PCIe card, has a mating edge region 72 with corresponding conductive pads 74 thereon, protruding forwards from one edge thereof. A alignment notch 75 is formed in the mating edge region 72 for receiving the corresponding key 21 in the central slot 22. A pair of mounting holes 76 are formed on two sides of the mating edge region 72. After assembled, the mating edge region 72 is received within the central slot 22, and the electronic card 70 is assembled to the housing 20 via a pair of screws 77 each extending through the corresponding securing hole 34 and mounting hole 76 and locked by a corresponding nut 79.

Compared with the conventional design using the inside connector for receiving an electronic card, in the inner side part, mounted upon the printed circuit board and indirectly connected to the cable which connects to the outside connector, the instant invention has the cable directly connected to the inside connector and the inside connector is equipped with a pair of side arms to directly lock the electronic card via screws extending through the corresponding side arms. Therefore, the whole connection system is simplified. It is noted that in this embodiment the front positioning block is unitarily formed on the housing while the rear positioning block is formed discretely. Anyhow, the front positioning block can be unified with the rear positioning block rather than with the housing.

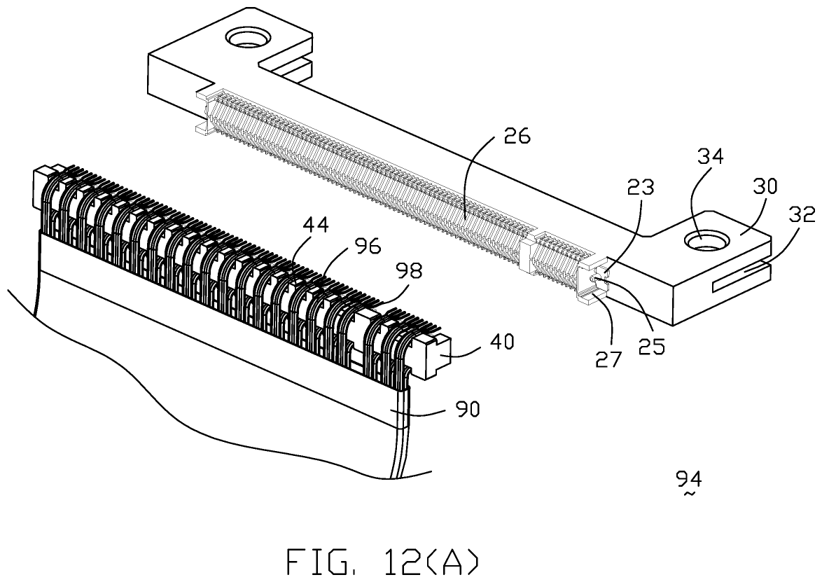

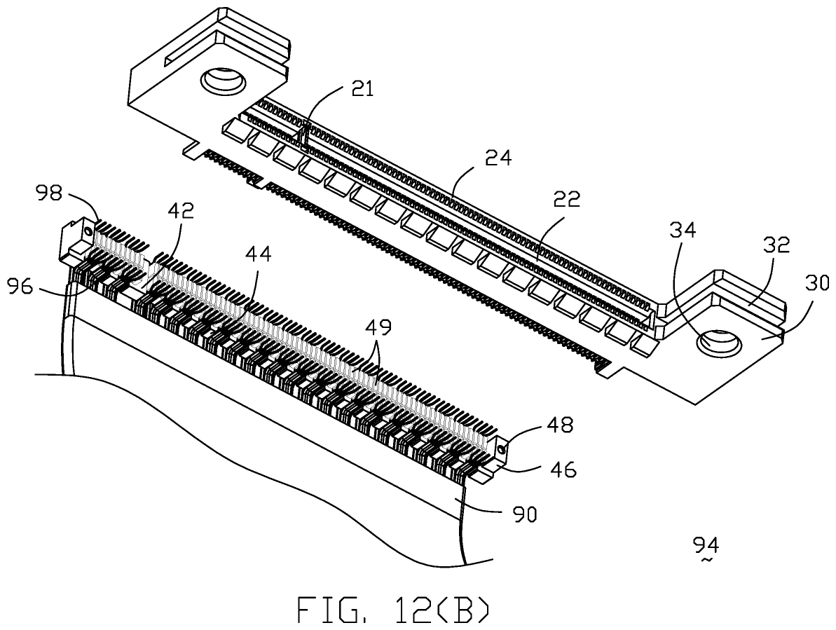

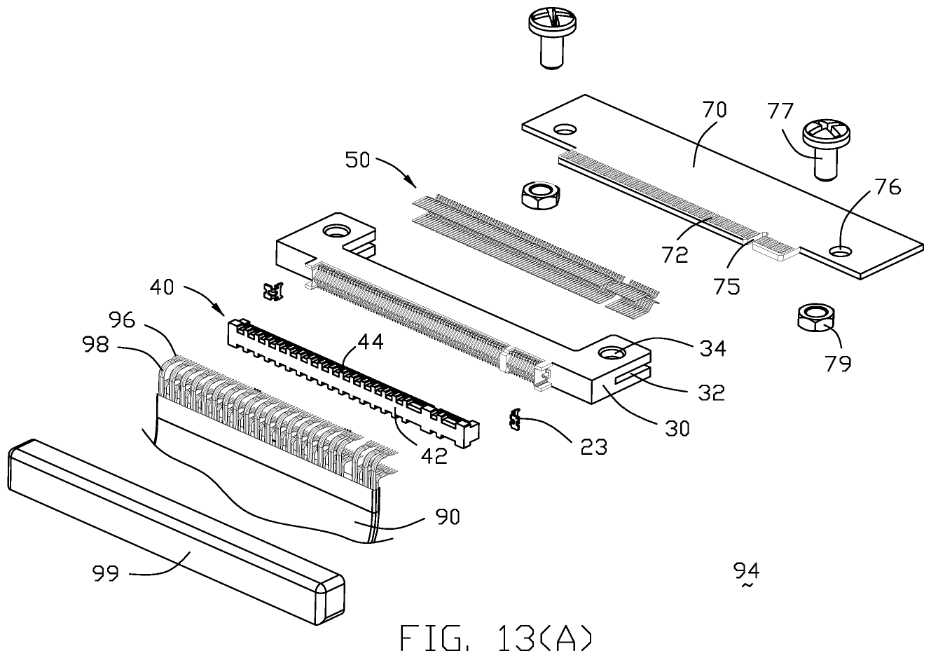

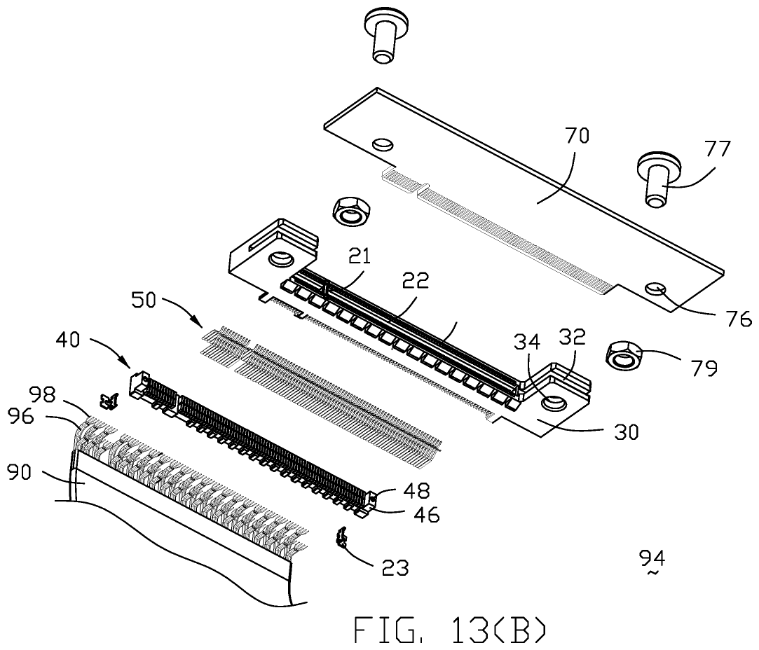

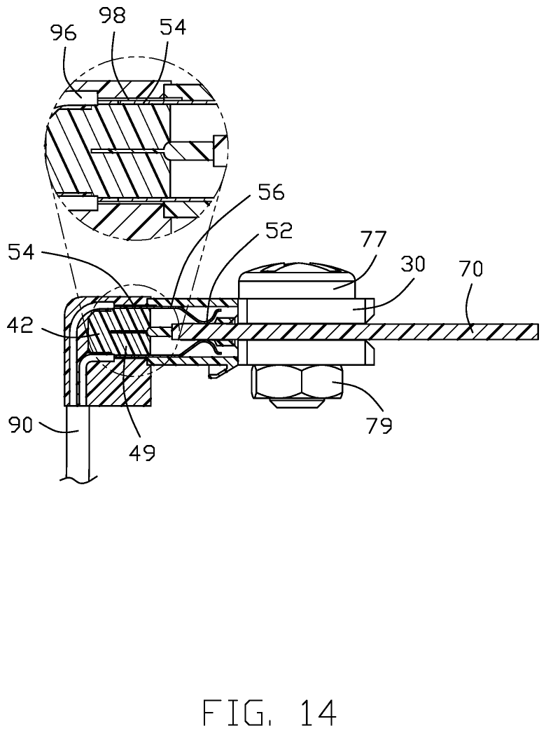

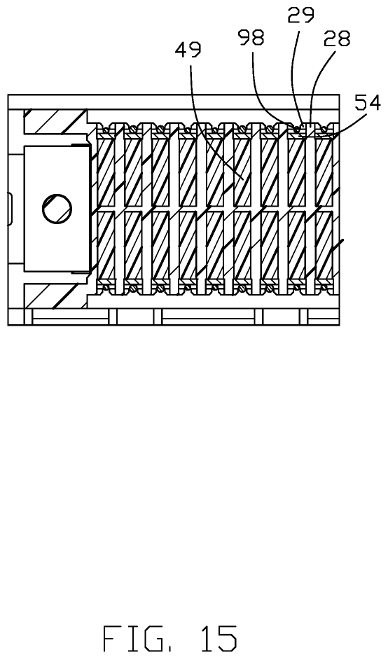

FIGS. 12-15 show another embodiment in which the rear positioning block 40 includes a plurality of ribs 49 forwardly extending from the main body 42 to be inserted into the corresponding passageways 24 for abutting against the connecting sections 54 of the corresponding contacts 50 in the transverse direction, respectively. In other words, the over-molding cover 99 does not enter the passageways 24.

While a preferred embodiment in accordance with the present disclosure has been shown and described, equivalent modifications and changes known to persons skilled in the art according to the spirit of the present disclosure are considered within the scope of the present disclosure as described in the appended claims.

What is claimed is:

1. An electrical assembly comprising:
a flat cable defining opposite inner side part and outer side part and including a plurality of coaxial wires;
the outer side part including an outer connector unit adapted to a printed circuit board;
the inner side part including a card edge electrical connector, the card edge connector comprising a longitudinal insulative housing defining a central slot along a longitudinal direction thereof, two rows of contacts disposed by two sides of the central slot in a transverse direction perpendicular to the longitudinal direction, each of the contacts including a front contacting section extending into central slot and a rear connecting section mechanically and electrically connected to the coaxial wires of the cable;
an electronic card comprising a front mating edge region inserted into the central slot; and
a fastening device securing the electronic card on the insulative housing.

2. The electrical assembly as claimed in claim 1, wherein the insulative housing includes a pair of side arms forwardly extending from two opposite longitudinal ends of the housing along a front-to-back direction perpendicular to both the longitudinal direction and the transverse direction, and the electronic card is sandwiched between each of the side arms in the transverse direction.

3. The electrical assembly as claimed in claim 2, wherein the fastening device is located on the corresponding side arm.

4. The electrical assembly as claimed in claim 3, wherein the fastening device comprising a screw extending through both the side arm and the electronic card in the transverse direction and locked with a nut.

5. The electrical assembly as claimed in claim 1, wherein the edge card connector includes a front positioning block around a rear side of the insultive housing to form a plurality of partitions to retain the connecting section of the contacts, respectively.

6. The electrical assembly as claimed in claim 5, wherein the edge card connector further includes a rear positioning block behind the front positioning block, and the rear positioning block forms a plurality of dividers to retain the corresponding wires, respectively.

7. The electrical assembly as claimed in claim 6, further including an over-molded cover to cover both the rear positioning block and the front positioning block.

8. An electrical assembly comprising:
a card edge connector comprising a longitudinal housing defining a central slot along a longitudinal direction thereof for receiving an electronic card, two rows of contacts disposed by two sides of the central slot, the contacts comprising contacting section extending into the central slot and rear connecting sections;
a pair of card fastening devices; and
a flat cable defining comprising a plurality of wires with a front end and a rear end opposite to the front end;
wherein the front ends of the wires are mechanically and electrically connected to the connecting sections of the contacts, respectively;
wherein the housing of the card edge connector further defining a pair of side arm forwardly extending from two opposite longitudinal ends of the housing, the pair of card fastening devices are disposed on the side arms, respectively and snuggly locking the electronic connector on the housing in a transverse direction perpendicular to the electric card.

9. The card edge connector assembly as claimed in claim 8, wherein the fastening device comprising a screw extending through both the side arm and the electronic card in the transverse direction and locked with a nut.

10. The card edge connector assembly as claimed in claim 8, wherein the edge card connector includes a front positioning block around a rear side of the insulative housing to form a plurality of partitions to retain the connecting section of the contacts, respectively.

11. The card edge connector assembly as claimed in claim 10, wherein the edge card connector further includes a rear positioning block behind the front positioning block, and the rear positioning block forms a plurality of dividers to retain the corresponding wires, respectively.

12. The card edge connector assembly as claimed in claim 11, further including an over-molded cover to cover both the rear positioning block and the front positioning block.

13. The card edge connector assembly as claimed in claim 11, wherein the rear positioning block further comprises a plurality of ribs protruding forwardly and abutting against the connecting sections of the contacts.
